(19) United States
(12) Patent Application Publication
(10) Pub. No.: US 2010/0190877 A1
(43) Pub. Date: Jul. 29, 2010

(54) BEAD FOAM MOLDINGS COMPOSED OF EXPANDABLE ACRYLONITRILE COPOLYMERS

(75) Inventors: Carsten Schips, Speyer (DE); Klaus Hahn, Kirchheim (DE); Ingo Bellin, Mannheim (DE); Daniela Longo, Siegburg (DE); Jens Assmann, Mannheim (DE); Andreas Gietl, Mannheim (DE); Jochen Gassan, Landau (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/666,956

(22) PCT Filed: Jun. 26, 2008
(86) PCT No.: PCT/EP08/58128

§ 371 Date: Dec. 28, 2009

(30) Foreign Application Priority Data
Jun. 28, 2007 (EP) 07111306.2

(51) Int. Cl. B29C 44/34

(52) U.S. Cl. 521/59

(57) ABSTRACT

Bead foam moldings obtainable by fusing prefoamed foam beads composed of expandable thermoplastic polymer granules, comprising

from 5 to 100% by weight of a component (A) comprising
a1) from 5 to 100% by weight (based on (A)) of an α-methylstyrene/acrylonitrile copolymer and/or α-methylstyrene/styrene/acrylonitrile terpolymer and
a2) from 0 to 95% by weight (based on (A)) of a styrene/acrylonitrile copolymer;
   from 0 to 95% by weight of polystyrene (B) and
   from 0 to 95% by weight of a thermoplastic polymer (C) other than (A) and (B),
   feature good thermal and solvent stability.

The invention relates to bead foam moldings which are obtainable by fusing prefoamed foam beads composed of expandable acrylonitrile copolymer-containing polymer granules, to acrylonitrile copolymer-containing foams, and to a process for producing the expandable acrylonitrile copolymer-containing polymer granules.

Processes for preparing expandable styrene polymers, such as expandable polystyrene (EPS), by suspension polymerization have been known for some time. These processes have the disadvantage that large amounts of wastewater are obtained and have to be disposed of. The polymers have to be dried in order to remove internal water. Moreover, suspension polymerization generally leads to broad bead size distributions, which have to be screened into different bead fractions in a laborious manner.

Moreover, expanded and expandable styrene polymers can be prepared by means of extrusion processes. In this case, the blowing agent is mixed into the polymer melt, for example by means of an extruder, conveyed through a die plate and granulated to beads or extrudates (U.S. Pat. No. 3,817,669, GB 1,062,307, EP-A 0 126 459, U.S. Pat. No. 5,000,891).

EP-A 0 668 139 describes a process for economically viable preparation of expandable polystyrene granule (EPS), wherein the blowing agent-containing melt is prepared in a dispersing, holding and cooling stage by means of static mixing elements and then granulated. Owing to the cooling of the melt to a few degrees above the solidification temperature, the removal of high amounts of heat is necessary.

In order to substantially prevent foaming after the extrusion, various processes for granulation, such as underwater granulation (EP-A 305 862), spray mist (WO 03/053651) or atomization (U.S. Pat. No. 6,093,750) have been proposed.

WO 98/51735 describes graphite particle-comprising expandable styrene polymers with reduced thermal conductivity, which are obtainable by suspension polymerization or by extrusion in a twin-screw extruder. Owing to the high shear forces in a twin-screw extruder, a significant molecular weight degradation of the polymer used and/or partial decomposition of additives added, such as flame retardants, is generally observed.

To achieve optimal insulating properties and good surfaces of the foam bodies, the cell count and foam structure which are established in the foaming of the expandable styrene polymers (EPS) are of crucial significance. The EPS granules produced by extrusion frequently cannot be foamed to give foams with optimal foam structure.

Expandable rubber-modified styrene polymers for elastic polystyrene foams are described, for example, in WO 94/25516, EP-A 682 077, DE-A 97 10 442 and EP-A 0 872 513.

WO 2005/06652 describes bead foam moldings having a density of from 10 to 100 g/l, which are obtainable by fusing prefoamed foam beads composed of expandable thermoplastic polymer granules comprising from 5 to 100% by weight of a styrene copolymer A), from 0 to 95% by weight of polystyrene B) and from 0 to 95% by weight of a thermoplastic polymer C) other than a) and b), and also processes for producing the expandable thermoplastic polymer granules.

The styrene copolymers (A) described are, for example, styrene-acrylonitrile copolymers (SAN).

Even though good results are already achieved in many sectors with the known foams, it is a constant task to improve such materials, for example with regard to solvent resistance, thermal stability, mechanical stiffness and blowing agent retention capacity. At the same time, it is desirable that new developments can be processed on the existing machines for EPS production.

It has now been found that bead foams and moldings produced therefrom can be obtained with particularly favorable properties when the underlying expandable thermoplastic polymer granules comprise an α-methylstyrene/acrylonitrile polymer component (AMSAN).

The invention therefore provides bead foam moldings obtainable by fusing prefoamed foam beads composed of expandable thermoplastic polymer granules, comprising

from 5 to 100% by weight of a component (A) comprising
a1) from 5 to 100% by weight (based on (A)) of an α-methylstyrene/acrylonitrile copolymer and/or a-methylstyrene/styrene/acrylonitrile terpolymer and
a2) from 0 to 95% by weight (based on (A)) of a styrene/acrylonitrile copolymer;
   from 0 to 95% by weight of polystyrene (B) and
   from 0 to 95% by weight of a thermoplastic polymer (C) other than (A) and (B).

The inventive bead foam moldings have a high solvent resistance, good thermal stability, high mechanical stiffness, good blowing agent retention capacity and good processability on EPS machines.

The invention further provides bead foams obtainable from polymer granules which comprise components (A) to (C), and also the use of the corresponding polymer granules for producing the inventive bead foams and bead foam moldings.

The bead foams generally have a density of from 5 to 500 g/l, preferably from 10 to 250 g/l, more preferably from 15 to 150 g/l.

The bead foam moldings have a high closed-cell content, generally more than 60%, preferably more than 70%, more preferably more than 80%, of the cells of the individual foam beads being closed.

More preferably, the thermoplastic polymer granule comprises

from 50 to 100% by weight of component (A) and
from 0 to 50% by weight of thermoplastic polymer (C).

Preferred components (A) are mixtures comprising

from 10 to 100% by weight, preferably from 20 to 100% by weight, more preferably
from 25 to 100% by weight, most preferably from 50 to 100% by weight (based in each case on (A)) of AMSAN polymer component (a1), and
from 0 to 90% by weight, preferably from 0 to 80% by weight, more preferably from 0 to 75% by weight, most preferably from 0 to 50% by weight (based in each case on (A)) of component (a2).

Preferred AMSAN polymer components (a1) are a-methylstyrene/acrylonitrile copolymers (a11).

Preferred are copolymers (a11) obtainable from
(a111) from 10 to 50% by weight, preferably from 17 to 43% by weight, particularly from 27 to 33% by weight (based on (a11)) of acrylonitrile and
(a112) from 50 to 90% by weight, preferably from 57 to 83% by weight, more preferably from 67 to 73% by weight (based on (a11)) of α-methylstyrene.

Further preferred AMSAN polymer components are α-methyl-styrene/styrene/acrylonitrile terpolymers (a12) obtainable from

(a121) from 61 to 85% by weight (based on (a12)) of α-methylstyrene,
(a122) from 1 to 15% by weight (based on (a12)) of styrene and
(a123) from 14 to 34% by weight (based on (a12)) of acrylonitrile.

Preferred styrene/acrylonitrile copolymers (SANs) (a2) are SAN types obtainable from

(a21) from 7 to 45% by weight, preferably from 17 to 35% by weight, (based on (a2)), of acrylonitrile and
(a22) from 55 to 93% by weight, preferably from 65 to 83% by weight, (based on (a2)), of styrene.

The polystyrene (B) used may be free-radically polymerized glass-clear polystyrene (GPPS), impact-modified polystyrene (HIPS) or anionically polymerized polystyrene (A-PS) or anionically polymerized impact-resistant polystyrene (A-IPS).

The thermoplastic polymers (C) used may, for example, be acrylonitrile-butadiene-styrene (ABS), acrylonitrile-styrene-acrylic ester (ASA), polyamide (PA), polyolefins such as polypropylene (PP) or polyethylene (PE), polyacrylates such as polymethyl methacrylate (PMMA), polycarbonate (PC), polyesters such as polyethylene terephthalate (PET) or polybutylene terephthalate (PBT), polyether sulfone (PES), polyether ketones (PEK) or polyether sulfides (PES), or mixtures thereof. Preference is given to polyamide (PA).

The composition of the polymer granules can be selected according to the desired properties of the bead foam molding. The inventive polymer mixtures improve the oil resistance and the solvent resistance, especially toward aromatic solvents, and the heat distortion resistance.

In order to obtain granule beads of minimum size, the die swell downstream of the die outlet should be minimized. It has been found that the die swell can be influenced, inter alia, by the molecular weight distribution of the AMSAN. The expandable AMSAN should therefore preferably have a molecular weight distribution with a polydispersity M_{w}/Mₙ of at most 3.5, more preferably in the range from 1.5 to 2.8 and most preferably in the range from 1.8 to 2.6.

Suitable compatibilizers are, for example, maleic anhydride-modified styrene copolymers, epoxy group-containing polymers or organosilanes.

The inventive bead foams can be produced by customary methods known to those skilled in the art, such as suspension polymerization. Preference is given, however, to melt impregnation, i.e. the contacting of the polymers with blowing agents in a melt stream, as described, for example, in WO 03/106544.

It is also possible for polymer recyclates of the thermoplastic polymers mentioned, especially styrene polymers and expandable styrene polymers (EPS) to be added to the polymer melt in amounts which do not significantly worsen its properties, generally in amounts of not more than 50% by weight, especially in amounts of from 1 to 20% by weight.

The blowing agent-containing polymer melt comprises generally one or more blowing agents in homogeneous distribution in a total proportion of from 2 to 10% by weight, preferably from 3 to 7% by weight, based on the blowing agent-containing polymer melt. Suitable blowing agents are the physical blowing agents typically used in EPS, such as aliphatic hydrocarbons having from 2 to 7 carbon atoms, alcohols, ketones, ethers, esters or halogenated hydrocarbons. Preference is given to using isobutane, n-butane, isopentane, n-pentane. Preferred co-blowing agents are ethanol, acetone and methyl formate.

To improve the foamability, finely distributed internal water droplets may be introduced into the polymer matrix. This can be done, for example, by the addition of water to the molten polymer matrix. In terms of location, the water can be added upstream of, with or downstream of the blowing agent metering. A homogeneous distribution of the water can be achieved by means of dynamic or static mixers.

In general, from 0 to 2% by weight, preferably from 0.05 to 1.5% by weight of water, based on the overall polymer component, are sufficient.

Expandable polymer granules with at least 90% of the internal water in the form of internal water droplets having a diameter in the range from 0.5 to 15 μm form foams with sufficient cell count and homogeneous foam structure when foamed.

The amount of blowing agent and water added is selected such that the expandable polymer granules have an expansion capacity α, defined as the bulk density before foaming/bulk density after foaming, of at most 125, preferably from 25 to 100.

The inventive expandable polymer granules generally have a bulk density of at most 700 g/l, preferably in the range from 590 to 660 g/l. When fillers are used, according to the type and amount of the filler, bulk densities in the range from 590 to 1200 g/1 may occur.

Additionally added to the polymer melt may be additives, nucleators, fillers, plasticizers, flame retardants, soluble and insoluble inorganic and/or organic dyes and pigments, for example IR absorbers such as carbon black, graphite or aluminum powder, together or spatially separately, for example by means of mixers or side extruders.

The inventive bead foams are suitable especially for the addition of mineral fillers such as glass fibers.

In general, the dyes and pigments are added in amounts in the range from 0.01 to 30% by weight, preferably in the range from 1 to 5% by weight. For the homogeneous and microdisperse distribution of the pigments in the styrene polymer, it may be appropriate especially in the case of polar pigments to use a dispersing assistant, for example organosilanes, epoxy-containing polymers or maleic anhydride-grafted styrene polymers. Preferred plasticizers are mineral oils, low molecular weight styrene polymers, phthalates, which may be used in amounts of from 0.05 to 10% by weight, based on the styrene polymer.

To produce the inventive expandable polymer granules, the blowing agent is mixed into the polymer melt. The process comprises the stages a) melt generation, b) mixing, c) cooling, d) conveying and e) granulation. Each of these stages can be performed by means of the apparatus or apparatus combinations known in plastics processing. Suitable mixing means are static or dynamic mixers, for example extruders. The polymer melt can be taken directly out of a polymerization reactor or be generated directly in the mixing extruder or a separate melt extruder by melting polymer granules. The melt can be cooled in the mixing units or in separate coolers. Useful granulation methods are, for example, pressurized underwater granulation, granulation with rotating blades and cooling by spray atomization of temperature control liquids or atomization granulation. Suitable apparatus arrangements for performing the process are, for example:

a) polymerization reactor—static mixer/cooler—granulator
b) polymerization reactor—extruder—granulator
c) extruder—static mixer—granulator
d) extruder—granulator

In addition, the arrangement may have side extruders for introducing additives, for example solids or thermally sensitive additives.

The blowing agent-containing polymer melt is conveyed through the die plate generally with a temperature in the range from 140 to 300° C., preferably in the range from 160 to 240° C. Cooling down to the region of the glass transition temperature is not necessary.

The die plate is heated at least to the temperature of the blowing agent-containing polymer melt. The temperature of the die plate is preferably in the range from 20 to 100° C. above the temperature of the blowing agent-containing polymer melt. This prevents polymer deposits in the dies and ensures trouble-free granulation.

In order to obtain marketable granule sizes, the diameter (D) of the die bores at the die outlet should be in the range from 0.2 to 1.5 mm, preferably in the range from 0.3 to 1.2 mm, more preferably in the range from 0.3 to 0.8 mm. Even after die swell, this allows granule sizes below 2 mm, especially in the range from 0.4 to 1.4 mm, to be established in a controlled manner.

Apart from via the molecular weight distribution, the die swell can be influenced by the die geometry. The die plate preferably has bores with an L/D ratio of at least 2, the length (L) referring to the die region whose diameter corresponds at most to the diameter (D) at the die outlet. The L/D ratio is preferably in the range of 3-20.

In general, the diameter (E) of the bores at the die inlet of the die plate should be at least twice as great as the diameter (D) at the die outlet.

One embodiment of the die plate has bores with a conical inlet and an inlet angle α of less than 180°, preferably in the range from 30 to 120°. In a further embodiment, the die plate has bores with a conical outlet and an outlet angle β of less than 90°, preferably in the range from 15 to 45°. In order to obtain controlled granule size distributions of the styrene polymers, the die plate can be equipped with bores of different outlet diameters (D). The different embodiments of the die geometry can also be combined with one another.

A particularly preferred process for producing the expandable polymer granules comprises the steps of
a) polymerizing α-methylstyrene monomers, if appropriate styrene and acrylonitrile or styrene to give α-methylstyrene copolymers (A) or polystyrene (B),
b) devolatilizing the resulting polymer melt,
c) if appropriate mixing the remaining polymers of components (A), (B) and (C),
d) mixing the blowing agent and if appropriate additives into the polymer melt by means of static or dynamic mixers at a temperature of at least 150° C., preferably 180-260° C.,
e) cooling the blowing agent-containing polymer melt to a temperature which is at least 120° C., preferably 150-200° C.,
f) discharging through a die plate with bores whose diameter at the die outlet is at most 1.5 mm and
g) granulating the blowing agent-containing melt.

In step g), the granulation can be effected directly downstream of the die plate underwater at a pressure in the range from 1 to 25 bar, preferably from 5 to 15 bar.

Owing to the polymerization in stage a) and devolatilization in stage b), a polymer melt is available directly for the blowing agent impregnation in stage c), and melting of polymers is not necessary. This is not only more economic but also leads to expandable polymers with low monomer contents, since the mechanical shear action in the melting region of an extruder, which generally leads to redissociation of monomers, is avoided. In order to minimize the monomer content, especially below 500 ppm, it is also appropriate to keep the mechanical and thermal energy input in all subsequent process stages as low as possible. Particular preference is therefore given to maintaining shear rates below 50/sec, preferably from 5 to 30/sec, and temperatures below 260° C., and also short residence times in the range from 1 to 20 minutes, preferably from 2 to 10 minutes, in stages c) to e). Particular preference is given to using exclusively static mixers and static coolers in the overall process. The polymer melt can be conveyed and discharged by pressure pumps, for example gear pumps.

A further means of reducing the monomer content and/or residual solvents such as ethylbenzene consists in providing, in stage b), high-level degassing by means of azeotroping agents, for example water, nitrogen or carbon dioxide, or performing polymerization stage a) anionically. Anionic polymerization leads not only to polymers with low monomer content but simultaneously to low oligomer contents.

To improve the processability, the finished expandable polymer granules may be coated by glyceryl esters, antistats or anticaking agents.

The inventive expandable thermoplastic polymer granules are prefoamed in a first step, preferably by means of hot air or steam, to give foam beads having a density in the range from 10 to 250 g/l and fused in a second step in a closed mold to give the inventive bead foam moldings.

Because of the higher initial rigidity in contrast to EPS bead foams the bead foams of the invention are particularly suitable for producing pallets. To improve the durability of the pallets they can optionally be glued with wood, plastics or metal, or coated on all sides with a plastic film, e.g. made of polyolefins or styrol-butadiene block copolymers.

The invention will be illustrated in detail by the examples without any intention to restrict it thereby.

### EXAMPLES

### Feedstocks

Luran VLP: SAN with an acrylonitrile content of 35% and MW 145 800 (commercial product from BASF SE)
Luran VLS: AMSAN with an acrylonitrile content of 31% and MW 101 000 (commercial product from BASF SE)
Luwax AH3: Nucleating agent, polyethylene wax with melting point 110-118° C. and MW 3500 (commercial product from BASF SE)

### Comparative Examples 1-3

### Table 1

In a ZSK 18 twin-screw extruder from Leitritz, 100% by weight of Luran VLP was melted at 230-250° C. Subsequently, the polymer melt was laden with 4.0% or 5.0% or 5.5% by weight of s-pentane based on the polymer matrix. Thereafter, the polymer melt was homogenized in two static mixers and cooled to 190° C. 0.2% by weight of Luwax AH3, based on the polymer matrix, was added as a nucleating agent via a side extruder to the blowing agent-laden main melt stream. After homogenization by means of two further static mixers, the melt was cooled to 140° C.-150° C. and extruded through a heated perforated plate (4 holes with 0.65 mm bores and perforated plate temperature 280° C.). The polymer strand was cut off by means of underwater granulation (underwater pressure 12 bar, water temperature 60° C.), so as to obtain a blowing agent-laden minigranule with narrow particle size distribution (d′=1.2 mm).

### Examples 1-4

### Table 2

In a ZSK 18 twin-screw extruder from Leitritz, 50% by weight of Luran VLP was melted with 50% by weight of Luran VLS at 230-250° C. Subsequently, the polymer melt was laden with 4.5 or 5.0% by weight of s-pentane based on the polymer matrix. Thereafter, the polymer melt was homogenized in two static mixers and cooled to 190° C. 0.2% by weight of Luwax AH3, based on the polymer matrix, as a nucleating agent was added via a side extruder to the blowing agent-laden main melt stream. After homogenization by means of two further static mixers, the melt was cooled to 140° C.-150° C. and extruded through a heated perforated plate (4 holes with 0.65 mm bores and perforated plate temperature 280° C.). The polymer strand was cut off by means of underwater granulation (underwater pressure 12 bar, water temperature 60° C.), so as to obtain a blowing agent-laden minigranule with narrow particle size distribution (d′=1.2 mm).

### Example 5

In a ZSK 18 twin-screw extruder from Leitritz, 50% by weight of Luran VLP was melted with 50% by weight of Luran VLS at 230-250° C. Subsequently, the polymer melt was laden with 5.0% by weight of s-pentane and additionally 1.0% by weight of ethanol based on the polymer matrix. Thereafter, the polymer melt was homogenized in two static mixers and cooled to 190° C. 0.2% by weight of Luwax AH3 (BASF product), based on the polymer matrix, as a nucleating agent was added via a side extruder to the blowing agent-laden main melt stream. After homogenization by means of two further static mixers, the melt was cooled to 140° C.-150° C. and extruded through a heated perforated plate (4 holes with 0.65 mm bores and perforated plate temperature 280° C.). The polymer strand was cut off by means of underwater granulation (underwater pressure 12 bar, water temperature 60° C.), so as to obtain a blowing agent-laden minigranule with narrow particle size distribution (d′=1.2 mm).

The blowing agent-containing granule was prefoamed in an EPS prefoamer to give foam beads with a density of 55 g/l and in an EPS automatic molding unit at an elevated pressure of 0.5 bar to give pallets.

TABLE 1
(comparative examples)

| | Comparative example | | |
|---|---|---|---|
| | C. Ex. 1 | C. Ex. 2 | C. Ex. 3 |
| Pentane (%) | 4.0 | 5.0 | 5.5 |
| Bulk density (g/l) | 95.6 | 106.6 | 23 |
| Cell count (1/mm) | 7.5 | 7.9 | 12.9 |
| Compressive stress (kPa) | | | |
| 10% compression | 851 | 1075 | 113 |
| 25% compression | 1092 | 1382 | 141 |
| (EN ISO 3386-1) | | | |

TABLE 2
(examples 1-4)

Example

| | 1 | 2 | 3 | 4 |
|---|---|---|---|---|
| Pentane (%) | 4.5 | 4.5 | 5.0 | 5.0 |
| Bulk density (g/l) | 67.6 | 75.2 | 48.5 | 26.7 |
| Cell count (1/mm) | 4.3 | 4.1 | 10.5 | 12.4 |
| Compressive stress (kPa) | | | | |
| 10% compression | 451 | 542 | 362 | 125 |
| 25% compression | 640 | 755 | 445 | 157 |
| (EN ISO 3386-1) | | | | |

As a result of the addition of the co-blowing agent ethanol in example 5, it was possible to significantly improve the processability (low bulk density <20 g/l) and the fusion of the foam beads in the later molding.

1-16. (canceled)

17. An expandable thermoplastic polymer granule comprising
from 5 to 100% by weight of a component (A) comprising
a1) from 5 to 100% by weight (based on A) of an α-methylstyrene/acrylonitrile copolymer and/or α-methylstyrene/styrene/acrylonitrile terpolymer and
a2) from 0 to 95% by weight (based on A) of a styrene/acrylonitrile copolymer;
from 0 to 95% by weight of polystyrene (B) and
from 0 to 95% by weight of a thermoplastic polymer (C) other than (A) and (B);
obtainable by a process comprising the steps of
a) polymerizing a-methylstyrene monomers, if appropriate styrene and acrylonitrile or styrene to give a-methylstyrene copolymers (A) or polystyrene (B),
b) devolatilizing the resulting polymer melt,
c) if appropriate mixing the remaining polymers of components (A), (B) and (C),
d) mixing one blowing agent such as aliphatic hydrocarbons having from 2 to 7 carbon atoms or halogenated hydrocarbons in a total proportion of from 2 to 10% by weight, based on the blowing agent-containing polymer melt, and ethanol, acetone or methyl formate as co-blowing agent and if appropriate additives into the polymer melt by means of static or dynamic mixers at a temperature of at least 150° C.,
e) cooling the blowing agent-containing polymer melt to a temperature which is at least 120° C.,
f) discharging through a die plate with bores whose diameter at the die outlet is at most 1.5 mm and
g) granulating the blowing agent-containing melt.

18. The expandable thermoplastic polymer granule according to claim 17 wherein the blowing agent is isobutane, n-butane, isopentane or n-pentane and the co-blowing agent is ethanol, acetone or methyl formate.

19. The expandable thermoplastic polymer granule according to claim 17, where the thermoplastic polymer granule comprises
from 50 to 100% by weight of component (A) and from 0 to 50% by weight of thermoplastic polymer (C).

20. The expandable thermoplastic polymer granule according claim 17, comprising as component (A) a mixture comprising
from 10 to 100% by weight (based in each case on (A)) of AMSAN polymer component (a1), and
from 0 to 90% by weight (based in each case on (A)) of component (a2).

21. The expandable thermoplastic polymer granule according to claim 20, comprising as component (A) a mixture comprising
from 20 to 100% by weight (based in each case on (A)) of AMSAN polymer component (a1), and
from 0 to 80% by weight (based in each case on (A)) of component (a2).

22. The expandable thermoplastic polymer granule according to claim 17, comprising as AMSAN polymer component (a1) an α-methylstyrene/acrylonitrile copolymer (a11).

23. The expandable thermoplastic polymer granule according to claim 22, where the copolymer (a11) is obtainable from
(a111) from 10 to 50% by weight (based on (a11)) of acrylonitrile and
(a112) from 50 to 90% by weight (based on (a11)) of α-methylstyrene.

24. The expandable thermoplastic polymer granule according claim 17, comprising as AMSAN polymer component (a1) an α-methylstyrene/styrene/acrylonitrile terpolymer (a12).

25. The expandable thermoplastic polymer granule according to claim 24, where the terpolymer (a12) is obtainable from
(a121) from 61 to 85% by weight (based on (a12)) of α-methylstyrene,
(a122) from ito 15% by weight (based on (a12)) of styrene and
(a123) from 14 to 34% by weight (based on (a12)) of acrylonitrile.

26. The expandable thermoplastic polymer granule according to claim 17, wherein a thermoplastic polyamide is added as component (C).

27. A bead foam molding obtainable by fusing prefoamed foam beads composed of expandable thermoplastic polymer granules according to claim 17.

28. The bead foam molding according to claim 27, wherein the bead foam has a density in the range from 10 to 250 g/l.

29. The bead foam molding according to claim 27 in the shape of a pallet.

30. A bead foam according to claim 27.

31. A process for producing expandable thermoplastic polymer granules according to claim 17, comprising the steps of
a) polymerizing α-methylstyrene monomers, if appropriate styrene and acrylonitrile or styrene to give α-methylstyrene copolymers (A) or polystyrene (B),
b) devolatilizing the resulting polymer melt,
c) if appropriate, mixing the remaining polymers of components (A), (B) and (C),
d) mixing one blowing agent such as aliphatic hydrocarbons having from 2 to 7 carbon atoms or halogenated hydrocarbons in a total proportion of from 2 to 10% by weight, based on the blowing agent-containing polymer melt, and ethanol, acetone or methyl formate as co-blowing agent, and, if appropriate, additives into the polymer melt by means of static or dynamic mixers at a temperature of at least 150° C.,
e) cooling the blowing agent-containing polymer melt to a temperature which is at least 120° C.,
f) discharging through a die plate with bores whose diameter at the die outlet is at most 1.5 mm and
g) granulating the blowing agent-containing melt.

32. The bead foam molding according to claim 18, wherein the bead foam has a density in the range from 10 to 250 g/l.

33. The bead foam molding according to claim 18, wherein the thermoplastic polymer granule comprises
from 50 to 100% by weight of component (A) and from 0 to 50% by weight of thermoplastic polymer (C).

34. The bead foam molding according to claim 19, wherein the thermoplastic polymer granule comprises
from 50 to 100% by weight of component (A) and from 0 to 50% by weight of thermoplastic polymer (C).

35. The bead foam molding according to claim 18, comprising as component (A) a mixture comprising
from 10 to 100% by weight (based in each case on (A)) of AMSAN polymer component (a1), and
from 0 to 90% by weight (based in each case on (A)) of component (a2).

36. The bead foam molding according to claim 19, comprising as component (A) a mixture comprising
from 10 to 100% by weight (based in each case on (A)) of AMSAN polymer component (a1), and
from 0 to 90% by weight (based in each case on (A)) of component (a2).
